(19) United States
(12) Patent Application Publication
(10) Pub. No.: US 2005/0027838 A1
(43) Pub. Date: Feb. 3, 2005

(54) System and method for intercepting user exit interfaces in IMS programs

(76) Inventor: Robert Mark Magid, Monroe Township, NJ (US)

Correspondence Address: John L. Rogitz;Rogitz & Associates, Suite 3120, 750 B Street, San Diego, CA, 92101, US

(21) Appl. No.: 10/629,431

(22) Filed: Jul. 29, 2003

(51) Int. Cl. G06F 15/173; G06F 9/46

(52) U.S. Cl. 709/223; 719/310

(57) ABSTRACT

A system and method for intercepting user exit interfaces in IMS programs includes installing a program library at an IMS system server as the first library in an IMS program library concatenation. The program library includes an interception routine. An interface routine resides at an IMS system server and can be dynamically loaded. During operation, the interception routine communicates with the interface routine to resolve name ambiguity and enable simultaneous use of a single exit by plural users.

### I. FIELD OF THE INVENTION

to The present invention relates generally to computer software, and more specifically IMS software.

### II. BACKGROUND OF THE INVENTION

A majority of corporate data in the United States and abroad resides on mainframe computers, e.g., S/390 mainframes manufactured by International Business Machines. Much of the information stored on mainframe computers is managed using information management system (IMS) applications. IMS applications can provide various exit points to allow customers to tailor the IMS system behavior to their specific needs. However, the IMS provided exit points only support a call to a single exit. Front end users, e.g., customers, and back end users, e.g., vendors, each contend for the exit interfaces and as such, it can be very complex to exploit a single interface. This situation becomes even more complex when multiple vendors contend for the same exit interface.

Typically, vendors direct a customer to rename a customer developed exit. Some vendors also recommend that the customer link-edit the customer developed exit with the vendor supplied exit. Other vendors dynamically load the renamed customer exit. The vendor supplied exit then receives control from the IMS system and in turn, calls the customer exit. Unfortunately, with these solutions customers have to coordinate the implementation of their user exit with the vendor's user exit. Also, ongoing maintenance to either or both exits is prone to regress each others implementation of those exits. And, many times one of the exits can get “lost” which can impact the availability or overall function of the IMS system.

The present invention has recognized these prior art drawbacks, and has provided the below-disclosed solutions to one or more of the prior art deficiencies.

### SUMMARY OF THE INVENTION

A method for intercepting user exit interfaces in IMS programs includes installing a program library at an IMS system server as the first library in an IMS program library concatenation. The program library includes an interception routine. An interface routine is dynamically loaded at the IMS system server. During operation, the interception routine communicates with the interface routine to resolve name ambiguity and enable simultaneous use of a single exit by plural users.

In a preferred embodiment, control is passed from an IMS program at the IMS system server to the interface routine. Moreover, control is received at the interception routine from the IMS program. The interception routine is established as a user exit routine. Further, the interception routine obtains the names of the libraries in an IMS program library concatenation. Each library in the IMS program library concatenation is dynamically allocated as a separately accessible file at the interception routine. Preferably, it is determined whether any of the libraries includes a load module with the same name as the interface routine. Any matching load module is flagged as an “candidate user-exit.”

Preferably, a “candidate user-exit” load module is compared to a predetermined interception routine “eye-catcher.” Any matching “candidate user-exit” load module is ignored. On the other hand, a non-matching “candidate user-exit” load module is treated as a user exit routine. Storage is obtained at the IMS system server and the user exit routine is brought into memory. Then, a directed load is issued for the user exit routine and control is passed to the user exit routine.

In another aspect of the preferred embodiment of the present invention, a system for intercepting user exist interfaces in IMS programs includes an IMS system server and a user computer communicating therewith. An interface routine and an interception routine reside in the IMS system server. The interface routine and the interception routine include logic means for communicating between the interface routine and the interception routine to resolve name ambiguity and enable simultaneous use of a single exit by plural users.

In still another aspect of the preferred embodiment of the present invention, a computer program device for intercepting user exit interfaces in IMS programs includes logic means for communicating between an interception routine and an interface routine to resolve name ambiguity and enable simultaneous use of a single exit by plural users.

### BRIEF DESCRIPTION OF THE DRAWINGS

The preferred embodiment of the present invention will now be described, by way of example, with reference to the accompanying drawings, in which:

FIG. 1 is a block diagram representing the present invention;

FIG. 2 is a flow chart of the operating logic of the present invention; and

FIG. 3 is a flow chart of the operating logic of the present invention.

### DESCRIPTION OF AN EMBODIMENT OF THE INVENTION

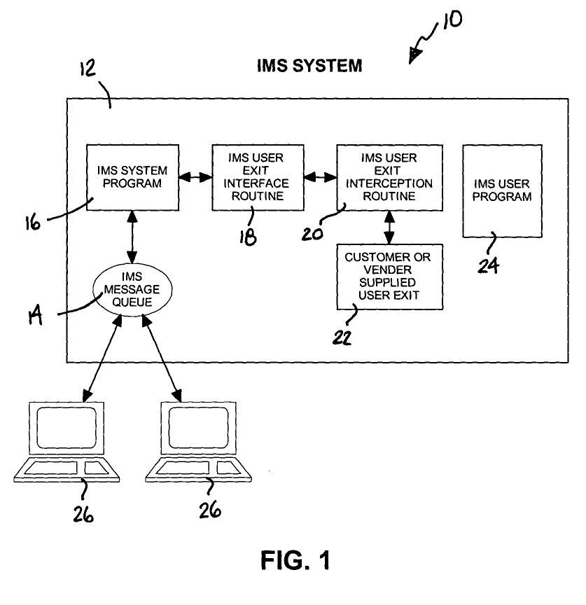

Referring initially to FIG. 1, an IMS system is shown and is generally designated 10. As shown, the system 10 includes an IMS system server 12. Within the IMS system server 12, is an IMS message queue 14 that communicates with an IMS system program 16. It is to be understood that an IMS program 16 can be software for managing data, e.g., software provided by International Business Machines. The IMS system program 16 communicates with an IMS user exit interface routine 18. Moreover, as shown, the IMS user exit interface routine 18 communicates with an IMS user exit interception routine 20. Further, the IMS user exit interception routine 20 communicates with a customer or vender supplied user exit 22. FIG. 1 also shows an IMS user program 24 within the IMS system server 12. It is to be understood that the IMS user program 24 is customer provided software that, e.g., can be used for tracking inventory, maintaining bank records, etc.

As shown in FIG. 1, one or more user computers 26 communicate with the IMS system server 12 via the IMS message queue 14, e.g., using a network connection. The network connection can be made through a local-area network (LAN), a wide-area network (WAN), a wireless wide-area network (WWAN), the Internet, or any other network well known in the art. It is to be understood that the IMS user exit interface routine 18 and the IMS user exit interception routine 20 can have the below-described functionality.

It is to be understood that in the system 10 described above, the logic of the present invention can be contained on a data storage device with a computer readable medium, such as a computer diskette. Or, the instructions may be stored on a magnetic tape, hard disk drive, electronic read-only memory (ROM), optical storage device, or other appropriate data storage device or transmitting device thereby making a computer program product, i.e., an article of manufacture according to the invention. In an illustrative embodiment of the invention, the computer-executable instructions may be written using mainframe assembler language. Moreover, the IMS user program 24 may be written using assembler, PL/I, FORTRAN, COBOL, Pascal, REXX, or Java.

The flow charts herein illustrate the structure of the logic of the present invention as embodied in computer program software. Those skilled in the art will appreciate that the flow charts illustrate the structures of computer program code elements including logic circuits on an integrated circuit, that function according to this invention. Manifestly, the invention is practiced in its essential embodiment by a machine component that renders the program elements in a form that instructs a digital processing apparatus (that is, a computer) to perform a sequence of function steps corresponding to those shown.

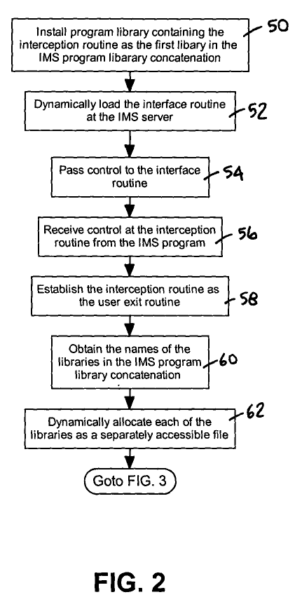

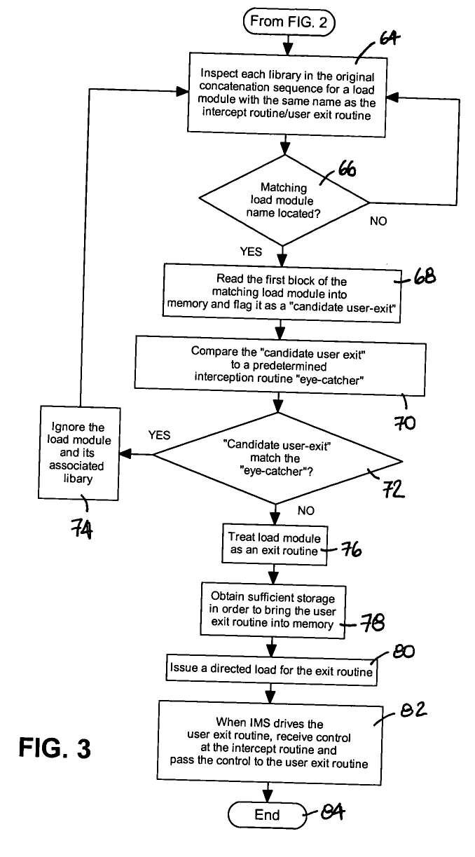

Referring now to FIG. 2, a preferred embodiment of the operating logic according to the present invention is shown and commences at block 50 wherein a program library containing the interception routine 20 is installed in an IMS system server 12 as the first library in the IMS program library concatenation. Moving to block 52, the interface routine 18 is dynamically loaded by the IMS system program 16. Further, at block 54, the IMS system server 12 passes control to the interface routine 18 much as it would pass control to a standard user exit. At block 56, control from the IMS system program 16 is received at the interception routine 20 from the interface routine 18. Next, the interception routine 20 is established as the user exit routine at block 58. Moving to block 60, the names of the libraries in the IMS program library concatenation are obtained by the interception routine 20 at the IMS system server 12. At block 62, each of the libraries is dynamically allocated as a separately accessible file by the interception routine 20. The logic then proceeds to FIG. 3.

Referring to FIG. 3, at block 64, each library in the original concatenation sequence is inspected by the interception routine 20 for a load module with the same name as the interface routine. Proceeding to decision diamond 66, it is determined whether a matching load module name is located. If not, the logic returns to block 64 and the library inspection continues. On the other hand, if a matching load module name is located, the logic moves to block 68 where the interception routine reads the first block of the matching load module into memory at the IMS system server 12 and flags the first block of the matching load module as a “candidate user-exit.” Moving to block 70, the “candidate user-exit” is compared to a predetermined interception routine “eye-catcher.” Thereafter, at decision diamond 72, it is determined whether the “candidate user-exit” matches the “eye-catcher.” If so, the load module and its associated library is ignored at block 74 (because the interception routine load module has been found) and the logic returns to block 64 and the library inspection by the interception routine continues as described above.

If the “candidate user-exit” does not match the “eye-catcher,” the logic moves to block 76 and the interception routine treats the “candidate user-exit” load module as an exit routine. Continuing to block 78, the interception routine obtains sufficient storage in order to bring the customer's user exit routine into memory. At block 80, the interception routine issues a directed load for the exit routine. Thereafter, at block 82, when the IMS system program 16 drives the user exit routine, control is received at the interception routine 20 and passed to the user exit routine. The logic then ends at state 84.

With the configuration of structure described above, it is to be appreciated that system and method described above provides a means for allowing multiple users exits to co-exist without renaming customer exit load modules or link-editing customer exits with vendor supplied exits. Name ambiguity is resolved and the simultaneous use of a single exit by plural users is enabled. Accordingly, customers are relieved from the coordination of implementing multiple exits. The chance of impacting IMS availability and overall function is substantially reduced.

While the particular SYSTEM AND METHOD FOR INTERCEPTING USER EXIT INTERFACES IN IMS PROGRAMS as herein shown and described in detail is fully capable of attaining the above-described aspects of the invention, it is to be understood that it is the presently preferred embodiment of the present invention and thus, is representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural and functional equivalents to the elements of the above-described preferred embodiment that are known or later come to be known to those of ordinary skill in the art are expressly incorporated herein by reference and are intended to be encompassed by the present claims. Moreover, it is not necessary for a device or method to address each and every problem sought to be solved by the present invention, for it is to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. section 112, sixth paragraph, unless the element is expressly recited using the phrase “means for.”

1. A method for intercepting user exit interfaces in IMS programs, comprising:
installing a program library at a user computer as the first library in an IMS program library concatenation, the program library including an interception routine;
dynamically loading an interface routine at the IMS system server; and
wherein the interception routine communicates with the interface routine to resolve name ambiguity and enable simultaneous use of a single exit by plural users.

2. The method of claim 1, further comprising:
passing control from an IMS program at the IMS system server to the interface routine.

3. The method of claim 2, further comprising:
receiving control at the interception routine from the IMS program.

4. The method of claim 3, further comprising:
establishing the interception routine as a user exit routine.

5. The method of claim 4, further comprising:
obtaining the name of each library in an IMS program library concatenation at the interception routine.

6. The method of claim 5, further comprising:
dynamically allocating each library in the IMS program library concatenation as a separately accessible file at the interception routine.

7. The method of claim 6, further comprising:
determining of any of the libraries includes a load module with the same name as the interface routine; and
flagging a first block of a matching load module as a “candidate user-exit.”

8. The method of claim 7, further comprising:
comparing a “candidate user-exit” load module to a predetermined interception routine “eye-catcher”; and
treating a non-matching “candidate user-exit” load module as a user exit routine.

9. The method of claim 8, further comprising:
obtaining storage at the IMS system server;
bringing the user exit routine into memory; and
issuing a directed load for the user exit routine.

10. The method of claim 9, further comprising:
passing control the user exit routine.

11. A system for intercepting user exist interfaces in IMS programs, comprising:
at least one IMS system server;
at least one user computer communicating with the IMS system server;
an interface routine residing in the IMS system server;
an interception routine residing in the IMS system server;
wherein the interface routine and the interception routine include logic means for:
communicating between the interface routine and the interception routine to resolve name ambiguity and enable simultaneous use of a single exit by plural users.

12. The system of claim 11, wherein the interface routine and the interception routine further include logic means for:
passing control from an IMS program at the IMS system server to the interface routine.

13. The system of claim 12, wherein the interface routine and the interception routine further include logic means for:
receiving control at the interception routine from the IMS program.

14. The system of claim 13, wherein the interface routine and the interception routine further include logic means for:
establishing the interception routine as a user exit routine.

15. The system of claim 14, wherein the interface routine and the interception routine further include logic means for:
obtaining the names of the libraries in a IMS program library concatenation at the interception routine.

16. The system of claim 15, wherein the interface routine and the interception routine further include logic means for:
dynamically allocating each library in the IMS program library concatenation as a separately accessible file at the interception routine.

17. The system of claim 16, wherein the interface routine and the interception routine further include logic means for:
determining whether any of the libraries includes a load module with the same name as the interface routine; and
flagging a first block of a matching load module as a “candidate user-exit.”

18. The system of claim 17, wherein the interface routine and the interception routine further include logic means for:
comparing a “candidate user-exit” load module to a predetermined interception routine “eye-catcher;” and treating a non-matching “candidate user-exit” load module as a user exit routine.

19. The system of claim 18, wherein the interface routine and the interception routine further include logic means for:
obtaining storage at the IMS system server;
bringing the user exit routine into memory; and
issuing a directed load for the user exit routine.

20. The system of claim 19, wherein the interface routine and the interception routine further include logic means for:
passing control the user exit routine.

21. A computer program device for intercepting user exit interfaces in IMS programs, comprising:
logic means for communicating between an interception routine and an interface routine to resolve name ambiguity and enable simultaneous use of a single exit by plural users.

22. The computer program device of claim 21, further comprising logic means for:
passing control from an IMS program at the IMS system server to the interface routine.

23. The computer program device of claim 22, further comprising logic means for:
receiving control at the interception routine from the IMS program.

24. The computer program device of claim 23, further comprising logic means for:
establishing the interception routine as a user exit routine.

25. The computer program device of claim 24, further comprising logic means for:
obtaining the names of the libraries in a IMS program library concatenation at the interception routine.

26. The computer program device of claim 25, further comprising logic means for:
dynamically allocating each library in the IMS program library concatenation as a separately accessible file at the interception routine.

27. The computer program device of claim 26, further comprising logic means for:
determining of any of the libraries includes a load module with the same name as the interface routine; and
flagging a first block of a matching load module as a “candidate user-exit.”

28. The computer program device of claim 27, further comprising logic means for:
comparing a “candidate user-exit” load module to a predetermined interception routine “eye-catcher;” and treating a non-matching “candidate user-exit” load module as a user exit routine.

29. The computer program device of claim 28, further comprising logic means for:
obtaining storage at the IMS system server;
bringing the user exit routine into memory; and
issuing a directed load for the user exit routine.

30. The computer program device of claim 29, further comprising logic means for:
passing control the user exit routine.
